(19) United States
(12) Patent Application Publication
(10) Pub. No.: US 2025/0174916 A1
(43) Pub. Date: May 29, 2025

(54) CONDUCTOR CRIMP STRUCTURE USING CONNECTION TERMINAL

(71) Applicants: UNION MACHINERY CO., LTD., KANAGAWA (JP); DELTA PLUS CO., LTD., MIE (JP)

(72) Inventors: KENICHI MITAMURA, KANAGAWA (JP); TSUGIO AMBO, SAITAMA (JP)

(21) Appl. No.: 18/950,180

(22) Filed: Nov. 18, 2024

(30) Foreign Application Priority Data
Nov. 24, 2023 (JP) 2023-199184
Mar. 13, 2024 (JP) 2024-038979

(51) Int. Cl. H01R 4/18; H01R 43/16

(52) U.S. Cl. CPC H01R 4/185; H01R 43/16

(57) ABSTRACT

A conductor made of a single wire is crimped and fixed securely by a conductor crimping portion to achieve the reliability of electrical connection. In a conductor crimping portion, first and second crimping pieces each having a two-layer structure of an inner layer plate and an outer layer plate are raised in a U-shape in advance. A conductor made of a single wire is disposed between the crimping pieces. The outer layer plate and the inner layer plate are pressed to caulk and fix the conductor from all sides. In caulking the conductor, pressing forces in two directions, which are a pressing force from below toward the center of the conductor and a pressing force from obliquely upward toward the center of the conductor, are applied to form non-pressing portions between the inner layer plate and the conductor between pressing portions making contact with the conductor.

### FIELD OF THE DISCLOSURE

The present invention relates to a conductor crimp structure using a small connection terminal that is placed, for example, in a connector housing and is fitted to a connection terminal of a counterpart connector.

### BACKGROUND OF THE DISCLOSURE

As electrical components become increasingly smaller, lighter, and more integrated, there has been a constant demand for a smaller connection terminal used to connect circuits. In view of this, JP2020-71920A discloses a crimp connection terminal for a thinned electric wire conductor, for example.

In the crimp connection terminal according to JP2020-71920A, crimping pieces have a two-layer structure, a void portion is formed between the crimping pieces having a two-layer structure, a conductor with a small diameter made of twisted wires in which a plurality of core wires is twisted is fixed by a caulking force having adequate elasticity to keep the void portion without being excessively deformed and so on due to an excessive caulking force, so that the conductor with a small diameter can be crimped and connected reliably.

In many conventional cases, a conductor to be crimped and connected to a crimp connection terminal is made of twisted wires in which a plurality of core wires is twisted, and the conductor itself has a certain degree of flexibility and plasticity. Thus, in a case where the crimp connection terminal having a void portion described in JP2020-71920A is used to crimp a conductor made of twisted wires by a caulking force with adequate elasticity, the conductor is not deformed unnaturally even when the conductor is a thin wire, and further, electrical properties such as conductivity and mechanical properties such as pull-out do not deteriorate.

### SUMMARY OF THE DISCLOSURE

However, in recent years, mainly for economic reasons, attempts have been made to use, for a signal wire to be connected to a connection terminal, a metal wire made of a single wire of copper alloy and the like as a conductor, and such a wire is an ultra-fine wire having a diameter of about 0.25 to 0.6 mm.

In a case where such a thin conductor made of a single wire is connected using a conventional terminal crimping piece, a crimp structure generally having the cross-section as illustrated in FIG. 12 is provided. However, unlike a conductor made of twisted wires, a conductor a made of a single wire has insufficient flexibility and plasticity, and is similar to a rigid body. Therefore, particularly in the case of a thin conductor a, even when the thin conductor a is fixed by a crimping piece b, the crimping piece b does not always caulk the periphery of the conductor a with an even caulking force. Therefore, a sufficient mechanical fixing force and electrical conductivity are not always achieved.

Further, in a case where a conductor with a small diameter made of a single wire is used, the conductor cannot be crimped favorably in many cases even with the crimp connection terminal having a void portion as described in JP2020-71920A, which easily causes mechanical/electrical problems. On the other hand, as to a normal conductor made of twisted wires, oxides and sulfides that form on the surface of the conductor and cause electrical disturbances are easily destroyed and removed during crimping. However, a conductor with a small diameter made of a single wire suffers from the problem that it is extremely difficult to remove such oxides and sulfides.

The invention has been accomplished in light of such circumstances, and therefore; an object of the invention is to provide a conductor crimp structure using a connection terminal that solves the problems described above, even when a conductor is made of a single wire, reliably caulks the conductor, and achieves a favorable fixing force and conductivity.

According to a conductor crimp structure using a connection terminal of the invention, a conductor made of a single wire is caulked by using a void portion provided in a crimping piece having a two-layer structure, and pressing portions for locally concentrating strong pressing forces on the conductor are provided at three locations. Further, non-pressing portions are provided between the conductor and the crimping pieces at three locations adjacent to the pressing portions. The non-pressing portions are configured with voids or do not apply a pressing force to the conductor even when the non-pressing portions are in contact with the conductor. This enables the conductor to be fixed by reliable caulking, resulting in mechanical/electrical reliability.

### BRIEF DESCRIPTION OF THE DRAWINGS

FIG. 1 is a perspective view of a crimp connection terminal for use;

FIG. 2 is a plan view of a punched conductive metal plate;

FIG. 3 is a perspective view of a conductor crimping portion in one step of a bending process;

FIG. 4 is a cross-sectional view of a crimping piece of a front crimping portion raised in a U-shape;

FIG. 5 is a cross-sectional view of a crimping piece of a rear crimping portion raised in a U-shape;

FIG. 6 is a diagram illustrating a state in which a conductor is placed in first and second crimping pieces of the front crimping portion;

FIG. 7 is a cross-sectional structural view in a crimping process 1 by the front crimping portion;

FIG. 8 is a cross-sectional structural view in a crimping process 2 by the front crimping portion;

FIG. 9 is a cross-sectional structural view in a crimping process 3 by the front crimping portion;

FIG. 10 is a cross-sectional structural view in a crimping process 4 by the front crimping portion;

FIG. 11 is a perspective view of a crimp connection terminal in a state where the conductor and an insulating covering portion are crimped and fixed; and

FIG. 12 is a cross-sectional view of a crimping and fixing structure for a conventional conductor made of a single wire.

### DETAILED DESCRIPTION OF THE EXEMPLARY EMBODIMENTS

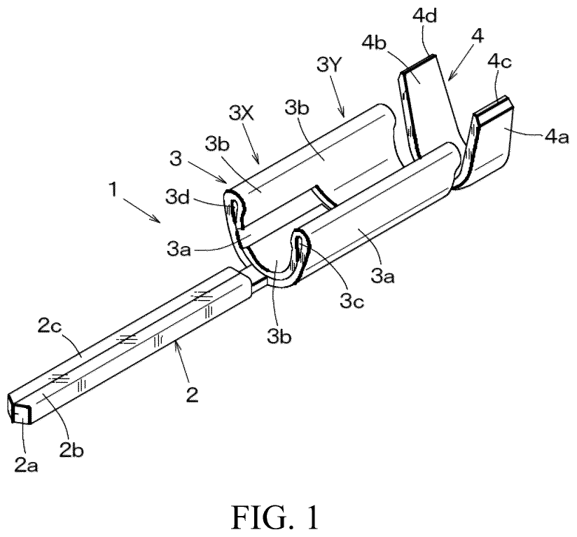

FIG. 1 is a perspective view of a crimp connection terminal 1 of an embodiment used in a conductor crimp structure using a connection terminal according to the invention. The crimp connection terminal 1 is made of, for example, a thin brass plate having a thickness of 0.1 mm. The crimp connection terminal 1 is formed by punching a single conductive metal plate whose both surfaces are plated with copper or tin in advance, and a connection portion, a crimping portion, and so on are formed by bending the conductive metal plate.

On the front side of the crimp connection terminal 1, a connection portion 2, e.g., a male insertion portion, which connects to a connection terminal of a counterpart connector is formed, and a conductor crimping portion 3 and a covering crimping portion 4 are provided sequentially on the rear side of the crimp connection terminal 1 in the longitudinal direction. Further, the conductor crimping portion 3 is divided into a front crimping portion 3X and a rear crimping portion 3Y from the front. In practice, the crimp connection terminal 1 is sometimes provided with a stabilizer for stabilizing its posture within a connector housing where the crimp connection terminal 1 is housed, a locking portion for preventing the crimp connection terminal 1 from coming out of the connector housing in the front-rear direction, and the like. However, known mechanisms thereof are omitted in the drawings.

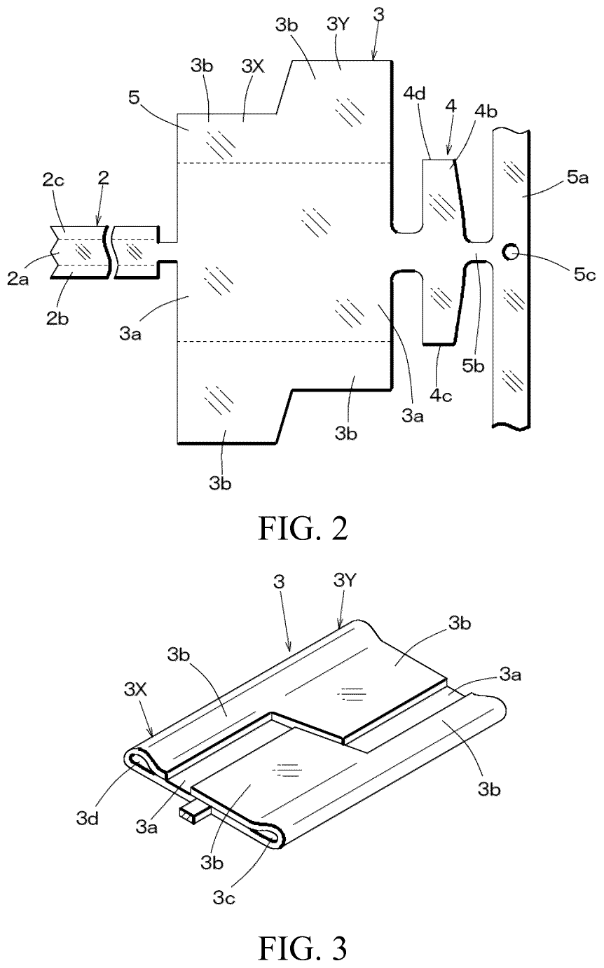

FIG. 2 is a plan view of a conductive metal plate in a punched state before the conductive metal plate is formed into the crimp connection terminal 1. The connection portion 2, the conductor crimping portion 3, and the covering crimping portion 4 are delimited as elements in a planar shape. Note that, in FIG. 2, the total length of the connection portion 2 is omitted.

Further to the rear in the covering crimping portion 4, a feed piece 5a for connecting the punched crimp connection terminals 1 is provided. The covering crimping portion 4 at the rear end of each crimp connection terminal 1 is connected to the feed piece 5a through a connection piece 5b. The feed piece 5a is formed with a pilot hole 5c, which is used to intermittently convey the conductive metal plate in the subsequent process of forming the connection terminal 1.

The conductive metal plate punched as described above is, for example, chamfered or surface-treated as necessary, and after that, is conveyed in the longitudinal direction by the feed piece 5a. In each forming process by a forming press, the connection portion 2, the conductor crimping portion 3, and the covering crimping portion 4 are bent sequentially, so that the crimp connection terminal 1 illustrated in FIG. 1 is formed. After that, the connection piece 5b is cut, and the crimp connection terminals 1 are separated individually.

As illustrated in FIGS. 1 and 2, the connection portion 2 is formed to be a two-layered rod-like male insertion end. Specifically, folded pieces 2b and 2c, which serve as an upper plate of the conductive metal plate, are folded upwards along dotted lines from both sides of a bottom plate 2a, which serves as a lower plate of the conductive metal plate, and further, edges of the folded pieces 2b and 2c are abutted against each other. Note that, in some cases, the connection portion 2 is formed to be another male connection portion or a female receiving connection portion.

As illustrated in FIG. 2, the front crimping portion 3X and the rear crimping portion 3Y of the conductor crimping portion 3 each include an outer layer plate 3a placed in the middle and two inner layer plates 3b that extend from both ends of the outer layer plate 3a in the width direction and are different in length in the width direction. Two dotted lines in the longitudinal direction of the conductor crimping portion 3 indicate positions at which the inner layer plates 3b are folded inwards from the outer layer plate 3a in a bending process described later.

FIG. 3 is a perspective view of the conductor crimping portion 3 in one step of the bending process. The front crimping portion 3X and the rear crimping portion 3Y each have a two-layer structure in which the inner layer plates 3b are folded inwards at folded portions from the upper end of the outer layer plate 3a to have an arc shape and are stacked. The width of one inner layer plate 3b of the front crimping portion 3X is long, while the width of the other inner layer plate 3b of the rear crimping portion 3Y is long. Further, void portions 3c and 3d whose cross-sectional shape is, for example, a water droplet shape, a balloon shape, a circular shape, an elliptical shape, or the like are provided in the longitudinal direction between the outer layer plate 3a and the inner layer plates 3b of the folded portions of the front crimping portion 3X and the rear crimping portion 3Y. Note that the void portion 3c of the front crimping portion 3X communicates with the void portion 3d of the rear crimping portion 3Y, while the void portion 3d of the front crimping portion 3X communicates with the void portion 3c of the rear crimping portion 3Y.

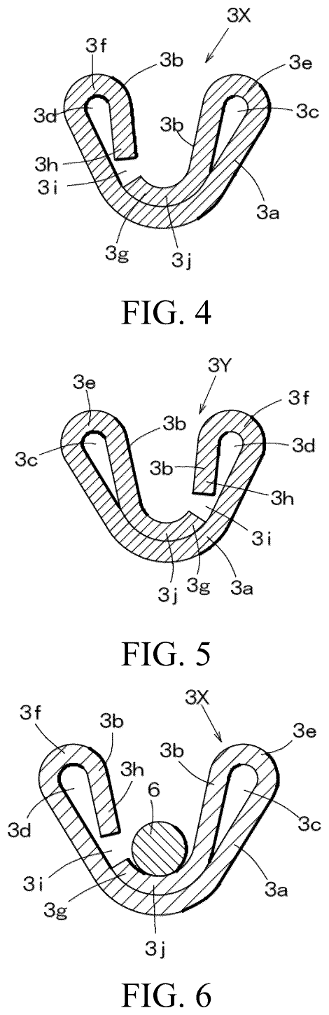

In the subsequent bending process, in each of the front crimping portion 3X and the rear crimping portion 3Y as illustrated in FIGS. 4 and 5 respectively, both the outer layer plate 3a and the inner layer plate 3b are raised in a U-shape obliquely upward as first and second crimping pieces 3e and 3f, respectively. The inner layer plate 3b on the first crimping piece 3e side of the front crimping portion 3X extends downward from the folded portion at the upper end of the outer layer plate 3a, an edge portion 3g covers a bottom portion formed by the outer layer plate 3a, and further, extends long upward along the outer layer plate 3a up to an approximate middle position of a raised portion of the second crimping piece 3f.

On the other hand, the inner layer plate 3b on the second crimping piece 3f side of the front crimping portion 3X extends downward from the folded portion at the upper end of the outer layer plate 3a, an edge portion 3h extends short up to an approximate middle position of a raised portion of the second crimping piece 3f. A gap 3i is formed along the outer layer plate 3a between the edge portion 3g and the edge portion 3h of the inner layer plate 3b.

The rear crimping portion 3Y is folded similarly to the front crimping portion 3X, but is symmetrical to the front crimping portion 3X. The reason why the front crimping portion 3X and the rear crimping portion 3Y are symmetrical is as follows. In a case where the length of the conductor crimping portion 3 is increased, the crimping force acting on the conductor is likely to become unbalanced on the left and right in the crimping process described later. To address this, the front crimping portion 3X and the rear crimping portion 3Y are made symmetrical to apply the crimping force evenly on the left and right to prevent the crimp connection terminal 1 from twisting.

In a case where a conductor made of a single wire is crimped and connected by the conductor crimping portion 3, first, as illustrated in FIG. 6, a conductor crimping apparatus is used for the conductor 6 that is made of a metal wire, for example, copper alloy, having a diameter of 0.32 mm, for example, with the insulating covering portion peeled off. The conductor 6 is inserted between the first and second crimping pieces 3e and 3f of the front crimping portion 3X of the conductor crimping portion 3, and is placed on the bottom portion 3j of the inner layer plate 3b. As to the rear crimping portion 3Y also, crimping on the same conductor 6 is performed simultaneously and similarly. However, the subsequent crimping process is described only for the front crimping portion 3X.

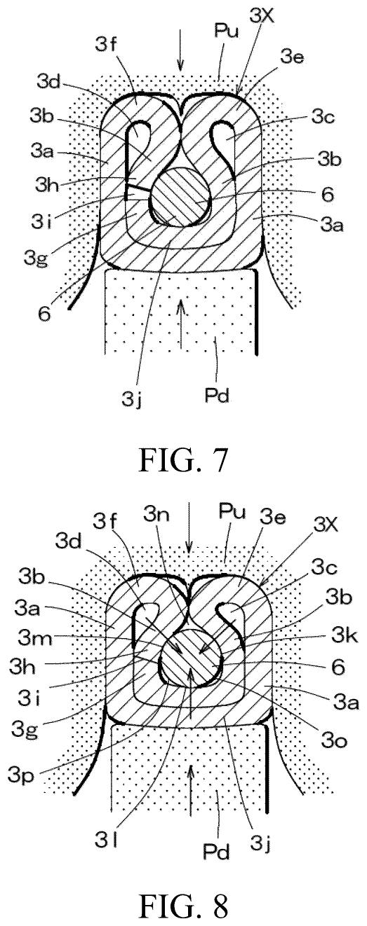

In the crimping process on the conductor 6 by the conductor crimping apparatus, the first and second crimping pieces 3e and 3f on which the conductor 6 is placed are disposed between an upper press mold Pu acting from above and a lower press mold Pd acting from below as illustrated in FIG. 7. Then, the upper press mold Pu is lowered and the lower press mold Pd is raised relatively. The upper press mold Pu and the lower press mold Pd are configured to operate without distinguishing between the front crimping portion 3X and the rear crimping portion 3Y.

As illustrated in FIG. 7, in a crimping process 1 using the upper press mold Pu and the lower press mold Pd, the first and second crimping pieces 3e and 3f are deformed according to the shapes of the upper press mold Pu and the lower press mold Pd to wrap the conductor 6. In the crimping step, the gap 3i between the edge portions 3g and 3h of the inner layer plate 3b is reduced by caulking the first and second crimping pieces 3e and 3f, and the void portions 3c and 3d are also reduced. Further, the side surfaces of the outer layer plate 3a are raised by the upper press mold Pu, and the bottom portion of the outer layer plate 3a and the bottom portion 3j formed with the inner layer plate 3b change from the U-shape to a flattened shape along the lower press mold Pd.

Further, as illustrated in FIG. 8, in a crimping process 2 by the operation of the upper press mold Pu and the lower press mold Pd, a strong caulking force is applied to the first and second crimping pieces 3e and 3f, so that the first and second crimping pieces 3e and 3f are further deformed to wrap the conductor 6. At this time, pressing forces are applied to the conductor 6 mainly from three directions indicated by arrows, that is, a pressing force toward the center of the conductor 6 from the bottom portion 3j direction, and pressing forces toward the center of the conductor 6 from both the left and right oblique directions. The pressing forces are applied from the three directions at angles spaced apart by approximately 120 degrees.

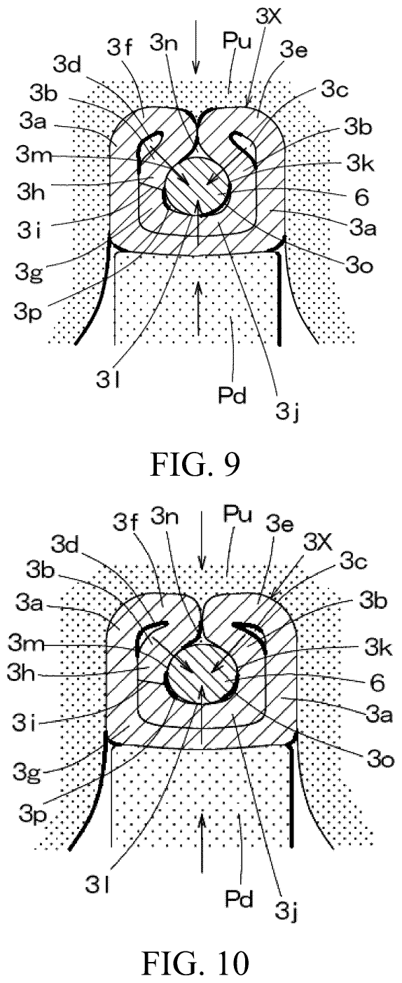

As illustrated in FIG. 9, in response to further caulking in a crimping process 3, the thickness of the outer layer plate 3a and the inner layer plate 3b increases in the first and second crimping pieces 3e and 3f, and also, the void portions 3c and 3d are further reduced. In the caulking step, the pressing forces by the upper press mold Pu and the lower press mold Pd are locally concentrated, particularly from the three directions mentioned above. At three locations where the pressing forces are concentrated, pressing portions 3k, 3l, and 3m where the inner layer plate 3b comes in contact with the conductor 6 are provided. Further, at three locations along the conductor 6 between the pressing portions 3k, 3l, and 3m, non-pressing portions 3n, 3o, and 3p are provided. The non-pressing portions 3n, 3o, and 3p apply no pressing force from the inner layer plate 3b to the conductor 6, and voids are formed between the inner layer plate 3b and the conductor 6 at the locations.

Stated differently, the pressing forces with which the conductor 6 is fixed to the outer surface of the conductor 6 are concentrated at the three locations, so that in the pressing portions 3k, 3l, and 3m, the coating made of oxides and sulfides of the conductor 6 at the corresponding portions can be destroyed and removed, leading to the enhancement in reliability of the electrical connection with the inner layer plate 3b.

When the pressing forces are applied by the upper press mold Pu and the lower press mold Pd, the following phenomena generally occur between the inner layer plate 3b and the conductor 6 before the pressing portions 3k, 3l, and 3m and the non-pressing portions 3n, 3o, and 3p are formed.

The outer layer plate 3a undergoes the pressing forces from the upper press mold Pu and the lower press mold Pd, and then, is deformed. The outer layer plate 3a is plastically deformed beyond the yield point. Therefore, even when the pressing operation by the upper press mold Pu and the lower press mold Pd is canceled, the outer layer plate 3a does not return to its original shape. In contrast, the inner layer plate 3b undergoes, through the outer layer plate 3a, the pressing forces from the upper press mold Pu and the lower press mold Pd. A part of the inner layer plate 3b that extends along the outer layer plate 3a is plastically deformed in a shape along the outer layer plate 3a.

As to a part of the inner layer plate 3b that extends along the void portions 3c and 3d, the pressing force applied to the inner layer plate 3b through the outer layer plate 3a is used to reduce the gap 3i between the edge portions 3g and 3h of the inner layer plate 3b, and after that, is used to reduce the void portions 3c and 3d. Therefore, even when the pressing force applied to the outer layer plate 3a exceeds the yield point of the outer layer plate 3a, the pressing force applied to the inner layer plate 3b does not immediately exceed the yield point of the inner layer plate 3b. In light of this, the difference in the way the pressing forces are applied to the outer layer plate 3a and the inner layer plate 3b is used. Thereby, as to the deformation of the inner layer plate 3b, it is possible to leave a part that remains elastically deformed without causing plastic deformation in the entirety of the inner layer plate 3b.

Accordingly, when the pressing operation by the upper press mold Pu and the lower press mold Pd is canceled, an elastic restoring force that the void portions 3c and 3d, which have been reduced by elastic deformation, expand back to their original sizes is generated in the inner layer plate 3b. The elastic restoring force tries to push back the parts of the inner layer plate 3b extending along the void portions 3c and 3d in a direction away from the outer layer plate 3a, that is, inward. At this time, the inner layer plate 3b, which is being pushed inward, comes into contact with the conductor 6 to press the same, and the inner layer plate 3b comes into contact with the conductor 6 with a biasing force, and the conductor 6 is eventually crimped between the inner layer plates 3b.

In this embodiment, the first and second crimping pieces 3e and 3f that enable the caulking described above are combined with the conductor 6 made of a single wire. As a result, the following functional effects are achieved.

In a case where a conductor is made of twisted wires in which a plurality of core wires is twisted, there are gaps between the core wires. Accordingly, in response to the conductor pressed by the inner layer plate 3b, the core wires move to fill the gaps therebetween. As a result, the overall shape of the conductor changes to a shape that conforms to the shape of a space surrounded by the inner layer plate 3b. Since the pressing force from the inner layer plate 3b is used to move the core wires, the pressing force applied to the core wires from the inner layer plate 3b is smaller than that for a case where the conductor is made of a single wire. Accordingly, the degree to which a coating such as oxides covering the surface of each core wire is destroyed is also small.

In contrast, in a case where the conductor 6 is made of a single wire, the conductor does not involve the movement of core wires, unlike the case where the conductor is made of twisted wires in which a plurality of core wires is twisted. Accordingly, the pressing force from the inner layer plate 3b continues to be concentrated at three locations of the conductor 6. As a result, although the contact area between the conductor 6 and the inner layer plate 3b is small, contact with a large biasing force is made possible in the pressing portions 3k, 3l, and 3m at the three locations where the conductor 6 and the inner layer plate 3b come into contact with each other, so that sufficient mechanical and electrical performance can be achieved, and further, the coating made of oxides and the like can be destroyed and removed.

The functional effects cannot be predicted from the case where a conductor made of twisted wires is used, and are newly discovered in the invention using the conductor 6 made of a single wire. That is, in a case where a conductor made of twisted wires is used, the conductor makes contact on the circumferential surface in the cross-section. In contrast, in a case where a conductor made of a single wire is used, the conductor makes contact at a plurality of points. Thus, the two concepts are different from each other.

As illustrated in FIG. 10, in a fourth process, the non-pressing portions 3n, 3o, and 3p are provided at three locations between the inner layer plate 3b and the upper and lower sides of the conductor 6 in addition to the void portions 3c and 3d to thereby caulk the conductor 6 by the outer layer plate 3a and the inner layer plate 3b. Thereby, the conductor crimp structure using the connection terminal in which the void portions 3c and 3d and the non-pressing portions 3n, 3o, and 3p are further reduced is achieved. With this structure, the conductor 6 is caulked reliably while maintaining the elasticity thereof, so that electrical/mechanical reliability is achieved.

Further, in the covering crimping portion 4, the outer side of the insulating covering portion 7 is caulked by a pair of covering crimping pieces 4a and 4b of the covering crimping portion 4 using a covering crimping apparatus that works in synchronization with the conductor crimping apparatus, and thereby side portions 4c and 4d are crimped so as to bite into the insulating covering portion 7. This enables the covering crimping portion 4 to fix the insulating covering portion 7 and to resist a pull-out force acting on the wire.

In the meantime, in FIG. 10, the non-pressing portions 3n, 3o, and 3p each having a void are formed when the conductor 6 is caulked by the pressing portions 3k, 3l, and 3m, crimped, and fixed. The non-pressing portions 3o and 3p may be configured to be in a non-pressing state even when the inner layer plate 3b and the conductor 6 come into contact with each other.

To be specific, the following configuration is possible. For the non-pressing portion 3o formed between the upper direction of the pressing force from the bottom portion 3j and the oblique lower left direction of the pressing force from the void portion 3c and the non-pressing portion 3p formed between the upper direction of the pressing force from the bottom portion 3j and the oblique lower right direction of the pressing force from the void portion 3d, the inner layer plate 3b and the conductor 6 are brought into contact with each other so as to form no void, and a void is formed only in the non-pressing portion 3n formed between the oblique lower left direction of the pressing force from the void portion 3c and the oblique lower right direction of the pressing force from the void portion 3d. Another configuration is also possible in which the inner layer plate 3b and the conductor 6 are brought into contact with each other with all of the non-pressing portions 3n, 3o, and 3p being in a non-pressing state so as to form no void.

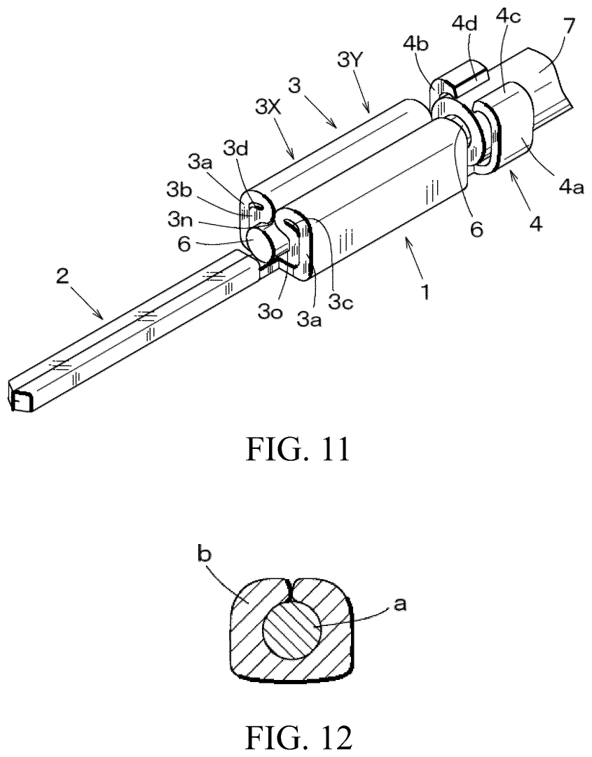

FIG. 11 illustrates a state in which the conductor 6 is crimped and connected by the front crimping portion 3X and the rear crimping portion 3Y of the conductor crimping portion 3 and the insulating covering portion 7 is crimped and fixed by the covering crimping pieces 4a and 4b of the covering crimping portion 4.

In the embodiment, the conductor crimping portion 3 includes the front crimping portion 3X and the rear crimping portion 3Y that are divided into the front and the back. However, instead of dividing the conductor crimping portion 3 in this way, the entirety of the conductor crimping portion 3 may have only any one of the shapes of the front crimping portion 3X and the rear crimping portion 3Y. Also, the length of the inner layer plate 3b may be equal and symmetrical on the left and right sides.

Further, in the embodiment, the void portions 3c and 3d are formed in advance in the crimp connection terminal 1. However, in the conductor crimping process, the void portions 3c and 3d can be formed between the outer layer plate 3a and the inner layer plate 3b depending on the shape of the upper press mold Pu.

What is claimed is:

1. A conductor crimp structure using a connection terminal, the connection terminal using a crimp connection terminal in which a conductor crimping portion is formed by punching and bending a conductive metal plate and a pair of crimping pieces raised in a U-shape from a bottom portion of the conductor crimping portion is provided to caulk and fix, by the crimping pieces, a conductor having a circular cross-section made of a single metal wire, wherein
each of the crimping pieces has a two-layer structure of an outer layer plate and an inner layer plate, the inner layer plate being folded inward from a folded portion of an upper end of the outer layer plate and stacked on the outer layer plate,
void portions are provided on an inner side of the folded portion between the outer layer plate and the inner layer plate, and are disposed on top, bottom, left, and right with respect to the bottom portion, and
between the inner layer plate and the conductor, three pressing portions and three non-pressing portions are provided, the three pressing portions being formed by deforming the inner layer plate by pressing forces in three directions concentrated from the bottom portion and a pair of the void portions toward a center of the conductor, and the three non-pressing portions being formed between the three pressing portions.

2. The conductor crimp structure using the connection terminal according to claim 1, wherein, in a case where the three pressing portions caulk the conductor to crimp and fix the conductor by contact with a biasing force from the three directions, a void is generated between the conductor and the inner layer plate at each of the three non-pressing portions.

3. The conductor crimp structure using the connection terminal according to claim 1, wherein the inner layer plate is in contact with the conductor in a non-pressing state in at least two non-pressing portions out of the three non-pressing portions, the two non-pressing portions being formed obliquely on both sides of the bottom portion.

4. The conductor crimp structure using the connection terminal according to claim 1, wherein the pressing forces in three directions on the conductor are applied from directions approximately 120 degrees apart.

5. The conductor crimp structure using the connection terminal according to claim 1, wherein the void portions provided between the outer layer plate and the inner layer plate are formed in advance in the crimp connection terminal.
